(19) United States
(12) Patent Application Publication
(10) Pub. No.: US 2014/0337711 A1
(43) Pub. Date: Nov. 13, 2014

(54) Automatic Website Generation

(71) Applicant: Quixo Facto Pty Ltd., Alexandria (AU)

(72) Inventors: Brett Poole, Alexandria, NSW (AU); Neil Wilkinson, Alexandria (AU); Justin O Neill, Alexandria (AU); Sebastian Urban, Alexandria (AU)

(21) Appl. No.: 14/276,839

(22) Filed: May 13, 2014

(30) Foreign Application Priority Data
May 13, 2013 (AU) 2013100640

(51) Int. Cl. G06F 17/22

(52) U.S. Cl. CPC G06F 17/2247
USPC 715/234

(57) ABSTRACT

Automatically generating a fully functional website from multiple different third-party websites associated with a common user may include receiving input identifying multiple third-party websites, establishing communication with the multiple third-party websites, aggregating existing digital content residing at each of the third-party websites, generating a new website based on at least some of the aggregated existing digital content, and deploying the generated new website. Changes made to the content at the new website may be propagated back to the original websites from which the content originated, thereby keeping the user's information consistent and up-to-date across multiple platforms.

### RELATED APPLICATION

This application claims priority under 35 U.S.C. §119 to Australian Innovation Patent No. 2013100640, filed May 13, 2013, which is incorporated herein in its entirety.

### BACKGROUND

One of the most important and most used segments on the internet is are the so-called “social media” sites where, for example, users may generate their own content, and display or otherwise make it available to the world at large, or to a select group of persons who are given access privileges.

The growth of in the number of persons using sites such as Facebook, Twitter, Soundcloud, Pitchfork, Instagram and/or the multiplicity of other social media internet sites has resulted in many of these sites becoming integral to their users' social and business lives.

A common feature of social media sites is the use of pre-formatted layouts whereby a user with negligible or no skill in the creation of Internet sites, can upload or otherwise insert text, images, graphical and audio-visual data, or the like into a site, thereby customizing the appearance and/or functionality of at least a portion of the site (e.g., the user's homepage or other pages to which the user has appropriate privileges). The use of pre-formatting enables the non-skilled user to “cut and paste” digital data into predetermined regions in the target page. Alternatively the user may follow prompts in order to place existing or newly created content into frames within the target site. The target site then applies predetermined algorithms in order to process the data in a way that enables that data to be preserved on the site's server(s) and presented to, or otherwise accessed by, persons using that site.

In contrast to pre-formatted layouts, the process of “authoring” internet sites such as websites from first scratch, typically requires knowledge of various, often complex, computer processes, and programming therefor, and knowledge of internet hosting, digital file manipulation as well as graphic and design skills. Consequently, for most persons and organizations seeking to create a customized internet site (typically referred to as a “website”), a specialist service provider is required—namely, a person or organization with the requisite skills to create the internet site, design the site both in terms of the material contained within it and the site's functionally, for example, the way the content is presented to and used by visitors to the site. The aesthetics of the site often are referred to as “User Experience” or “UE,” while the mechanics of controlling what and how users may interact with the information within the site is commonly referred to as User Interface” or “UI.”

Depending on complexity, the cost of creating a website can be substantial, ranging from thousands to many millions of dollars. For many organizations, a website is central to their marketing strategy, and for many organizations, not having a website is not an option due to the commercial ramifications of having no presence on the internet. Large or well-resourced organizations typically have a multiplicity of pages on the Internet—using a range of social media sites as well as a custom website. Often an organization's social media pages will direct visitors to those sites to go to the organization's website.

### SUMMARY

Aspects of the present disclosure includes systems and methods for automatically constructing a stand-alone, fully operational website (herein a “Quixomatic Website”) ranging from a single homepage to a hierarchical website with multiple pages that use existing digital data gathered from third party internet sites, whether these be social media sites or otherwise. In one implementation of the system, a subscriber/user of the system provides URLs (“Uniform Resource Locators” which act as addresses or pointers to content or other resources) to the social media or other sites of their choice. The system allocates a URL to that subscriber, then the system is deployed to access each of those social media sites and extract a copy of at least a portion of the digital data contained therein. That data is collected and analyzed using algorithms applied to create a fully operational Quixomatic Website populated by data collected from the subscriber's social media pages. The data is collected and the subscriber confirms (e.g., via input received in response to a prompt from the system) that all the collected digital data is legally available for deployment in the Quixomatic Website being constructed. The system automatically produces a layout and populates same with subscriber's data and the resulting Quixomatic Website is hosted for as long as the subscriber wishes same to be hosted. As the subscriber updates or amends or adds to their social media pages, those updates can be automatically detected by the system and incorporated into the Quixomatic Website.

In another implementation, by use of the present system, amendments made to the Quixomatic Website may be automatically propagated back upstream to the sites from which the data was originally extracted, enabling Subscribers to more efficiently update a multiplicity of social media sites by amending a single site rather than having to visit, enter and amend that party's data as it appears in each such social media site or as the case may be.

In various implementations, methods, systems, data processing apparatus, and/or non-transitory machine-readable media may be configured to perform the following functions.

In an implementation, data processing apparatus automatically creates and makes available a website by receiving input identifying a plurality of third-party websites, establishing communication with each of the plurality of third-party websites, aggregating existing digital content residing at each of the plurality of third-party websites, automatically generating a new website based on at least some of the aggregated existing digital content, and deploying the generated new website.

The generated new website may include a customized user interface, or a customized user experience, or both, unrelated to any of the third party websites. Each of the plurality of third-party websites may have an association with a common subscriber, wherein the subscriber has an account with each of the third-party websites. Establishing communication with the plurality of third-party websites may involve accessing the subscriber's account on each of the plurality of third-party websites. The existing digital content may include content personal to the subscriber including one or more of photos, videos, customized applications, or documents.

Automatic creation and deployment of a website may further include receiving input from the subscriber via the deployed new website, determining that the received input effects a change to one or more of the existing digital content items that were used to generate the new website, and propagating the change back to one or more third-party websites that host a copy of the one or more digital content items that were changed at the deployed new website. Propagating the change may involve transmitting a changed version of the digital content item to the one or more third-party websites. The plurality of third-party websites may include one or more of social media sites, video aggregators, photo-sharing sites, listing sites, or blogging sites.

Establishing communication with each of the plurality of third-party websites may be performed serially or in parallel, or a combination of both. Similarly, aggregating existing digital content residing at each of the plurality of third-party websites may be performed serially or in parallel, or a combination of both.

Automatically generating the new website may include determining one or more new colors for the new site based on colors appearing in the aggregated digital content.

The aggregated digital content may include a plurality of digital photos, and in that case, automatically generating the new website may include generating a slide-show experience and gallery features from the plurality of digital photos. The aggregated digital content may include text, and in that case, automatically generating the new website may include generating a blog post from the text. The aggregated digital content may include meta information, and in that case, automatically generating the new website may include generating site modules and html meta content from the meta information. The aggregated digital content may include information defining transactional behavior, and in that case, automatically generating the new website may include generating transactional experiences including one or more of phone call actions/buttons, buy now buttons, get directions, email forms, or chat modules from the information defining transactional behavior.

Automatically generating the new website may further include sensing a change to digital content in the newly generated website, and syncing the change to digital content with one or more third-party websites from whence the digital content originated. A third-party website may be automatically polled to determine whether a change to an existing digital content item residing at that website has occurred. Upon determining that a change has occurred, information corresponding to the change from the third-party website may be retrieved and used to update the newly generated website.

Input may be received from the subscriber corresponding to a refresh request. In response, the system may communicate with the third-party websites to aggregate any new or changed digital content, and use the aggregated new or changed digital content to update the newly generated website.

The system may collect online identities (e.g., a username), each online identity relating to a subscriber's access to a third-party website. Establishing communication with the third-party websites may be performed using the collected online identities. Collecting the online identities may be performed automatically using third-party search services.

The foregoing and other features, aspects, and potential advantages will become apparent from the description, the figures, and the claims.

### BRIEF DESCRIPTION OF THE DRAWINGS

FIG. 1 is a block diagram showing components of, and process flow, for the Site Generator.

FIGS. 2-4 are screenshots showing various aspects of the user interface for the Quixomatic website generation system.

FIG. 5-11 show aspects of user interfaces and their uses in connection with the website generation system.

FIG. 12 is a block diagram of computing devices 1200, 1250 that may be used to implement the systems and methods described in this document, as either a client or as a server or plurality of servers.

### DETAILED DESCRIPTION

In response to the costs and time delays commonly experienced by persons wanting a website, various software developers have created software applications that produce formatted websites. These applications are intended for users who wish to produce websites using their own data on a do-it-yourself basis. WordPress is typical of such an application. It is a much-used application for so-called “blogs,” which aims to provide an application for users wishing to have a low-cost website that they may update themselves, even with relatively low computer skills, without recourse to a third party specialist.

However, even applications such as WordPress and its ilk, require a level of computer literacy that is beyond the capacity of many persons, or require an unacceptable (e.g., to the intended user) amount of time and work to build and maintain. These applications require the user to create new content and to insert that content into the website in a particular way or the site will not operate either at all or in a way that will alienate visitors to the site.

Moreover, initial creation of the website is not the end of the process: once created, users are likely to want to keep the content of their website current or at least to refresh it so as to encourage visitors to make return visits to the site. This process of maintaining by enhancing and adding to the UI and the UE can be onerous in terms of the workload and the need to devote significant amounts of time to insert the new material which itself may need to be created or, at the very least, copied or transferred from another source.

Moreover, in some fields of commercial endeavor, users want a website but are restrained because the needs for a website may be for an indeterminate but relatively short time. One example of this would be a start-up band or a performing artist.

For many users, regardless of whether they need or want a website, they create and propagate a significant amount of original material via social media sites. Social media sites such as Facebook and Instagram encourage users to upload comments and/or audio-visual or graphical material about their lives and those with whom they interact. As a result, many users spend a substantial amount of time on an internet-connected device such as a computer, or suitably capable mobile telephone or tablet, posting and/or viewing material on one or more social media sites.

Increasingly, these social media sites are frequented by commercial organizations (e.g., vendors or advertisers) seeking to interact with existing customers, and to garner more customers via the various methods deployed by social media sites (e.g. Facebook's “like” or Foursquare's use of geo-location data, which users share with others on the site as a way of identifying popular locations in the “real” world). For many such organizations, these social media postings are a vital part of their marketing campaigns. Because social media sites typically require negligible computer or design skills, being fully formatted, many small commercial organizations find them the optimal way to have an Internet presence.

However, these social media pages tend to have limitations: for example, some permit customization but typically the degree of customization permitted is quite limited. Or a social media page might be just one of millions on the host site so it lacks a unique identity. Moreover, with most social media pages, the UI and UE are predetermined and may be less than ideal or may be changed by the social media operator with no reference to those with pages within the site.

Because social media pages are hosted within the overall social media site, individual users may not have access to metrics or statistics, e.g., the quantity of visitors and/or from whence they were referred; this denies the business the opportunity to track where new customers are coming from and/or how visitors to the page came to know about the business' social media page.

For many the barriers to entry to having a dedicated website are insurmountable, yet many regularly update the data on their pages whether in response to changes in their circumstances, changes in the commercial offerings, or a need to alert potential or current customers of events such as closures, changes in commercial terms etc.

The system and techniques described herein enable a user to create a website by redeploying the existing information already created and inserted into social media pages to which the user subscribes, or otherwise has access. This capability is of particular use and value to commercial enterprises (e.g. hotels, persons providing entertainment services, travel services, etc.) who want the benefits of a customizable, personalized website but cannot devote the time and/or the money needed to create new content and/or are insufficiently conversant with internet and web page authoring, to create the page or to carry out the maintenance and updating of content.

The subject system may be implemented as a computer system that enables users of the system to have a website created and hosted for them, without the need for them to create any additional material and/or to insert existing material into a pre-formatted website template. The subject system may use industry standard processes to extract digital data then residing in one or more specified social media pages related to the Subscriber, collating and analyzing same, and presenting it in a new format with distinctive and new UI and UE including aesthetics such as background colors, fonts and layout.

Among other advantages, the subject system does this process automatically across a range of social media sites. In addition, the subject system is fully hosted and produces an entirely new compilation of existing data in a way which differentiates the Quixomatic Website from the source pages within social media sites. Moreover, by use of the present system, amendments made to the Quixomatic Website may be automatically propagated back upstream to the sites from which the data was originally extracted, enabling Subscribers to more efficiently update a multiplicity of 3^{rd} Party Sources by amending a single site rather than having to visit, enter and amend that party's data as it appears in each such 3^{rd} Party Source. For example, a Subscriber changes the contact email address of the business within the Subscriber Customization Console whereby this change can be propagated to the 3^{rd} Party Sources automatically.

### TERMINOLOGY

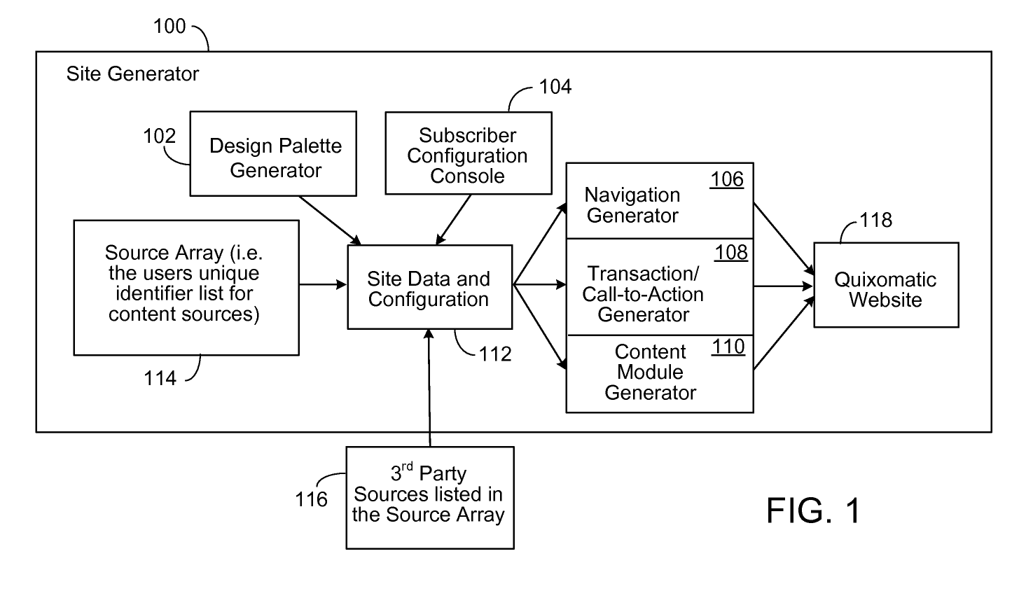

### With Reference to FIG. 1

Quixomatic Website 118—is the site that is generated by the system according to the Subscriber's data in their 3^{rd} Party Sources. The data from the 3^{rd} Party Sources is gathered, processed, stored during the Site Generator process and displayed according to the selected theme. Each theme is able to generate a different Quixomatic Website optimized for mobile, tablet and desktop sized screens.

Subscribers—Subscribers are defined as the people that use quixomatic.com to generate a Quixomatic Website 118 from their 3^{rd} party content. By way of example, Bill is a subscriber: he manages Yokozuna Sydney and has created his Quixomatic Website using the system. The Subscriber is not necessarily a paying customer.

Administrators—These are Quixomatic employees that can access super-user features of the system. By way of example, Brett is MD of Quixomatic and is able to activate a live Quixomatic Site on behalf of a Subscriber whilst talking to a Subscriber on a sales call.

Quixomatic Website Visitors—these are the Subscribers' users. By way of example, Yokozuna Sydney has many visitors to their Quixomatic Website every month, the individuals who access the Yokozuna Sydney's Quixomatic Website via mobile and Internet browsers are defined as “Quixomatic Website Visitors”.

Subscriber Customization (or Configuration) Console 104—the interface through which a Subscriber makes customizations to their Quixomatic Website. By way of example, a Subscriber will modify colors, fonts, 3^{rd} Party Sources of their Quixomatic Website through the usage of the Subscriber Customization Console.

3^{rd} Party Sources 116—By way of example, 3^{rd} party sources may include the third party social media sites and/or content applications, or other platforms available to the Subscriber or to the system, to be identified as sources for the Quixoamtic Website build. Typical examples include Facebook, Twitter, Soundcloud, Instagram, Google+, etc. Platforms such as Opentables, Shopify, OpenMenu and eBay also maintain API (Application Program Interface) infrastructure for the purpose of content distribution. A multiplicity of Quixomatic Websites may be added to the system through creation of API connections between the relevant 3^{rd} Party Source and the system.

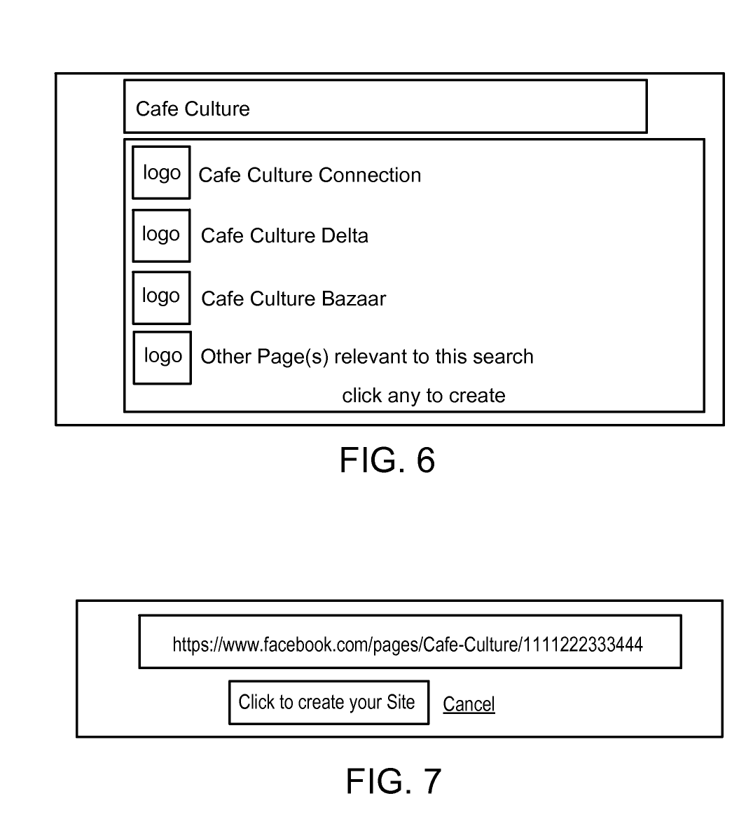

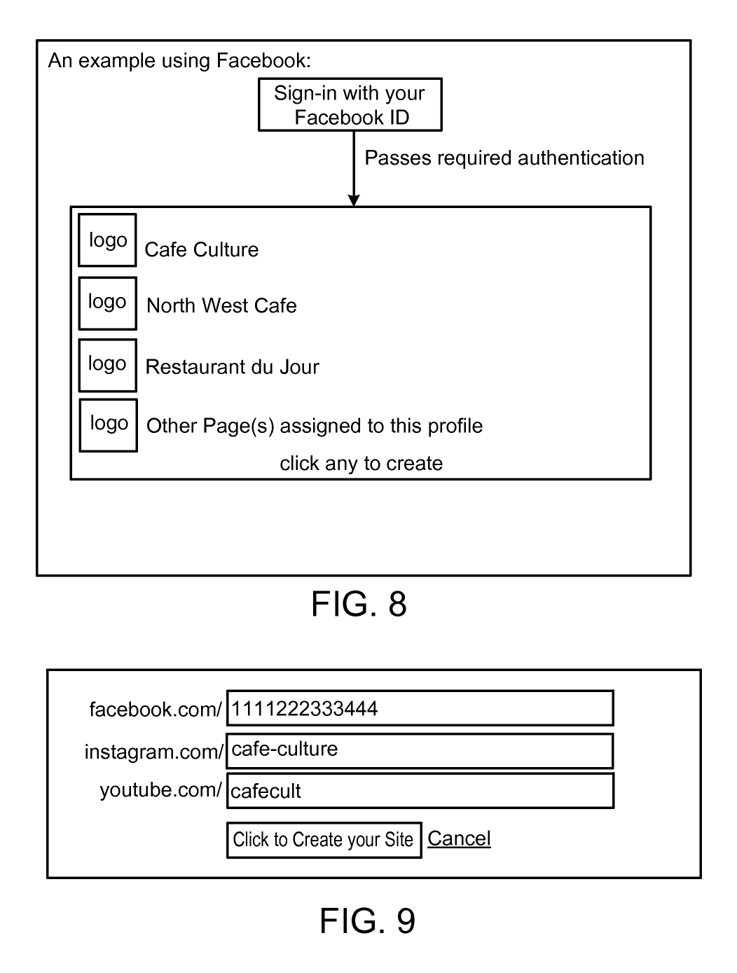

Source Array 114: A Source Array is a list of online identities and/or unique identifiers that may include particular items designated and identified to be copied and incorporated into the Quixomatic Website. Commonly, a Source Array is populated by access keys (or usernames) employed on other websites, platforms and applications to identify their account and/or content. By way of example, these unique identifiers can be provided directly to the system manually by the Subscriber (FIG. 7 and FIG. 9) or via the system interacting with 3^{rd} party search service(s) (FIG. 6) to automatically collate the correct unique identifier(s) into a list that will populate the Source Array.

Site Generator 100: By way of example, a site generator, or site generation engine, may include one or more software processes, developed as part of the system, that provide a mechanism for using APIs to access social media pages and content applications/platforms to produce the Quixomatic Website. This process is outlined in FIG. 1.

Design Palette Generator 102: Content assets collected via APIs identified in the source array are programmatically inspected to determine additional information that can be used to automatically allocate settings such as background colors, foreground colors, accent colors, palette variations, and the like. The specific selections are set via an algorithm developed to generate and highlight coordinated color options.

Content Module Generator 110: By way of example, a content module generator may include one or more software processes designed to inspect the type of content available to the system and to generate pages including what and where on the pages the content modules should appear. The specific selections can be set via an algorithm developed to highlight the most important content to the subscriber and their audience.

Navigation Array Generator 106: By way of example, a navigation array generator may include one or more software processes designed to inspect the type of content available to the system and to generate navigational items including which navigational items should be incorporated into the to-be created Quixomatic Website, and to which resources they should point. The specific selections are set via an algorithm developed to highlight the most important areas of the Quixomatic Website to the subscriber and their audience. For example, a Subscriber who has connected Youtube and Soundcloud may have “Video” and “Music” added to the main navigation, footer navigation, sitemaps, etc.

Transaction/Call-to-Action Generator 108: By way of example, a transaction/call-to-action generator may include one or more software processes designed to inspect the source array and content available to the system to generate transactional items including an identification of the prominent transactional items. The specific selections are set via an algorithm that highlights the one or more most important transaction methods of the Quixomatic Website insofar as they relate to the Subscriber and the Subscriber's intended audience (i.e. the Quixomatic Website Visitors). For example, a Subscriber who has connected a restaurant table booking application such as “Dimmi” or “OpenTables” may see the system feature a transactional widget, button or application prominently and automatically displayed to maximize lead generation for the Quixomatic Website.

Free Period: By way of example, a Quixomatic Website may be the resulting website assembled for the Subscriber by the system, which is available to the Subscriber for a finite period of time at no cost. Effectively this allows the potential Subscriber to “try before they buy.” When the subscription or purchase is completed, the temporary nature of the website is removed and the Quixomatic Website becomes active and continues to be accessible on the Internet. Should the Subscriber not complete the purchase process, the Quixomatic Website may become automatically unavailable to the public on the Internet.

### Exemplary Implementations:

In one implementation, a Subscriber's experience in operating the system, starts on the system's homepage. The Subscriber locates and identifies their chosen Facebook page. The Subscriber may also paste in a full Facebook page URL to begin the process. Should the Subscriber search for their business, they will be presented with search results powered by Facebook. Other sites or platforms may be substituted for Facebook.

Upon selecting their business or pasting their Facebook URL into the search box, the Quixomatic Website creation process begins and the Subscriber is shown a loading box while the necessary data, content and media is retrieved. Upon retrieval, the data, content and media is analyzed and the unique characteristics of the Quixomatic Website are set. Unique characteristics include, theme selection, color palette generation, content module settings, navigation and transaction module settings. The settings are determined based on a number of factors including category, content existence/comprehensiveness, inspecting media for color information, valid contact/transaction methods.

The Subscriber is then returned to the main console where the appearance and aesthetics of the newly created Quixomatic Website may be customized, data providers may be added and the Subscriber may configure the domain name of their newly created Quixomatic Website.

The Subscriber then completes the commercial terms relevant to the particular implementation of the system. For example, the Subscriber interacts with the system to input information to facilitate payment for his or her subscription for the ongoing hosting of their Quixomatic Website. Typically, a subscription is for a finite, renewable, indefinite term—the newly created Quixomatic Website will remain active and publicly accessible on the Internet for as long as the subscription is deemed active.

### Subscriber Customization Console 104

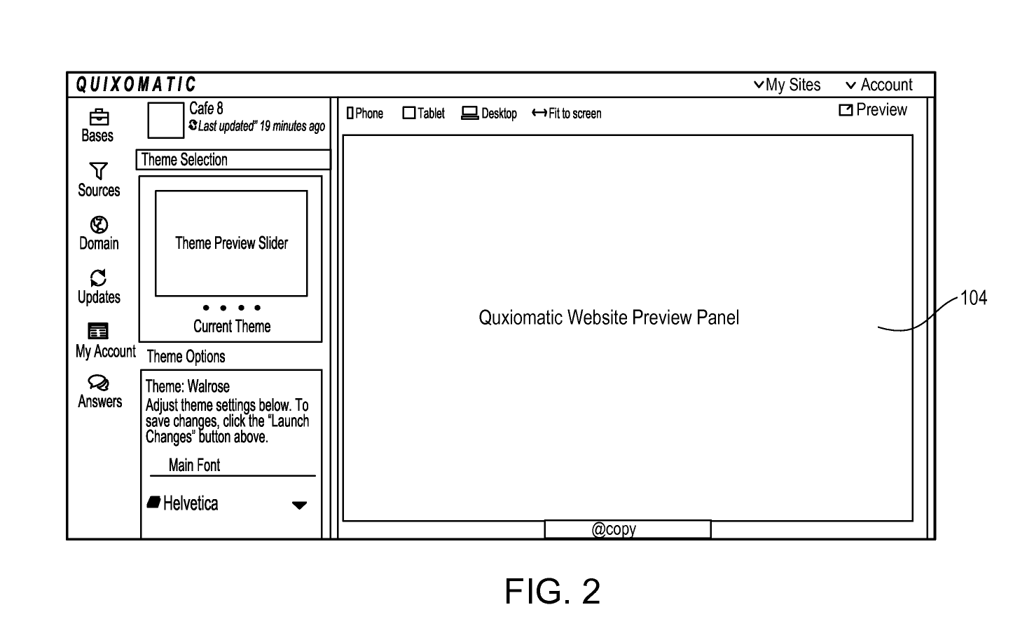

As shown in FIG. 2, the Subscriber Customization Console 104 is the interface by which Subscribers preview the resulting site and through which the Subscriber is presented with a number of controls to assist the Subscriber to further customize the newly created Quixomatic Website 118. These customizations may include the addition of navigational tabs, configuration of colors, fonts, backgrounds and overall themes. Theme templates can change the entire design, layout and aesthetics of the Quixomatic Website. Analytics solutions and contact forms (to promote communication between Subscriber/Quixomatic Website Visitors) can also be configured here.

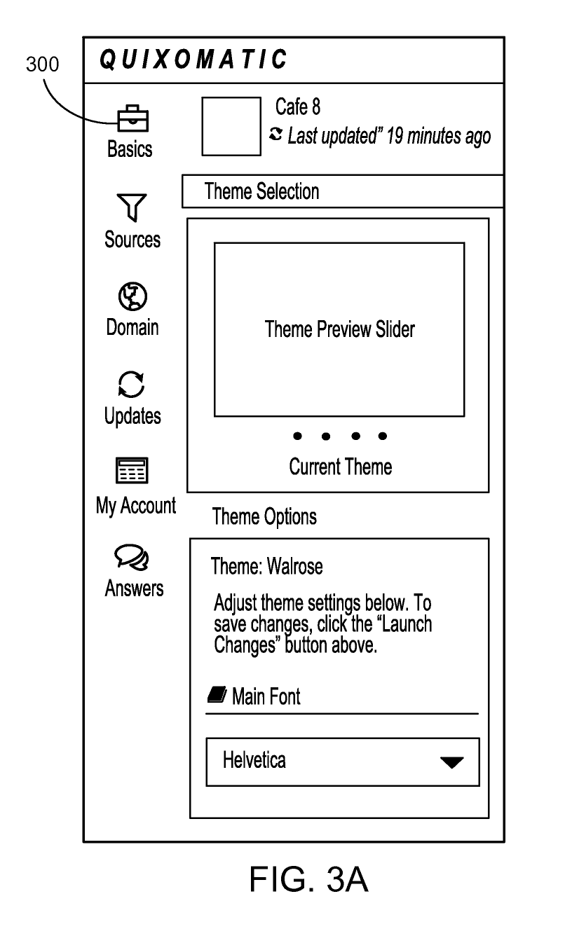

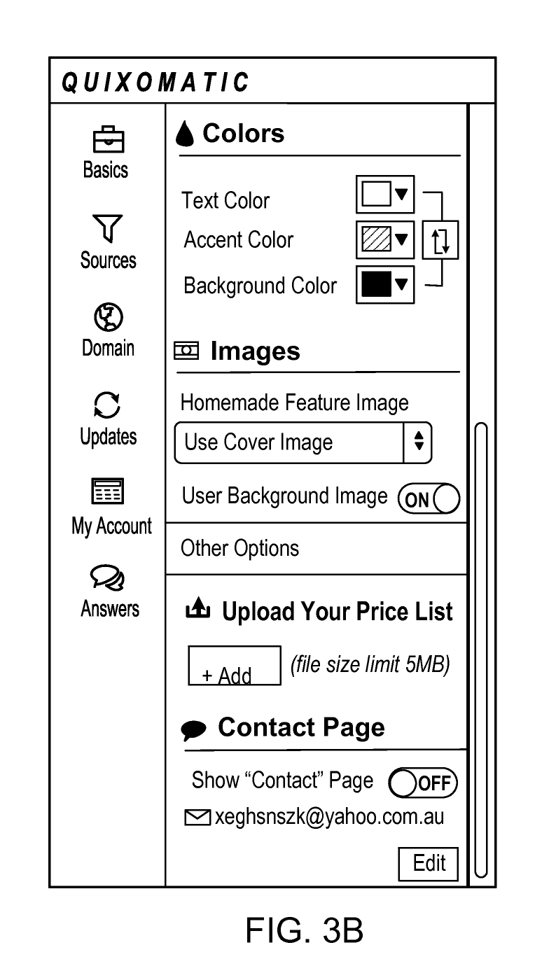

As shown in FIGS. 3A and 3B, in the Subscriber Customization Console, the “Basics” tab 300 lists a number of variations the Subscriber can make to effect some of the design and construction decisions made during build. For example, the Subscriber can change theme, layout, fonts, colors, background and foreground images, activate feature albums, upload pdfs and set a new email address for contact forms.

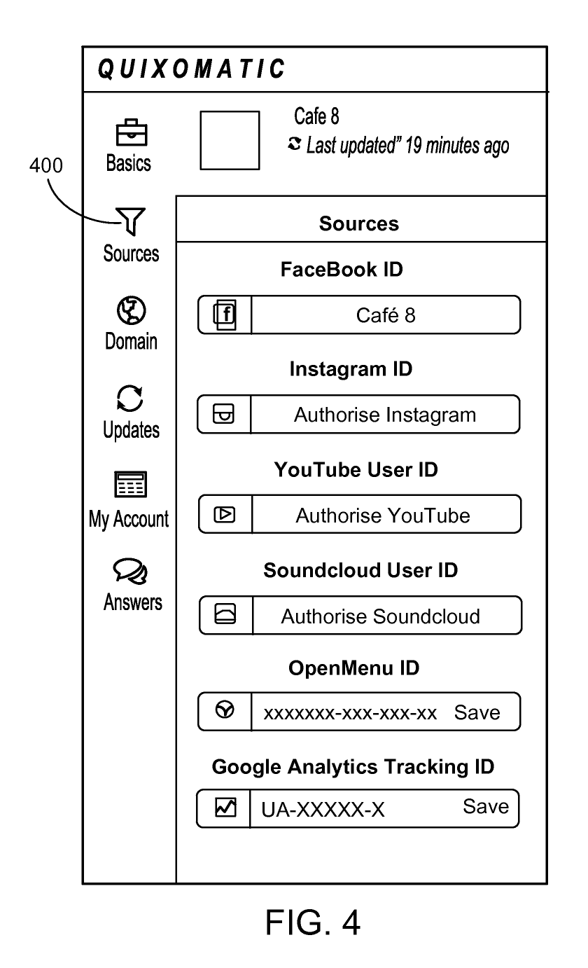

As shown in FIG. 4, in the Subscriber Customization Console, the “Sources” tab 400 lists a number of other social media and content applications that may also be connected to populate areas of the resultant Quixomatic Website.

One example: a Subscriber's Instagram account may be connected to their Quixomatic Website via the Sources tab. This action will result in the Subscriber's Instagram content populating additional photo albums in the photo gallery section of the resultant Quixomatic Website. Another example: a Subscriber's YouTube account may be connected to the Quixomatic Website via the Sources tab. This action will result in the Subscriber's YouTube content populating a new section of the Quixomatic Website and a new navigation item being created in the main navigation module. YouTube may also be connected to provide a “video” page and feature module of the Quixomatic Website. Soundcloud may be connected to provide the facility to play audio files available from that platform on their Quixomatic Website.

As more platforms are added, additional third party content applications may be made available to the Subscriber in order to power and populate areas of the site. This can include booking modules relevant for restaurants and accommodation Subscribers as an example. E-commerce, catalogues, menus, price lists held in content marketplaces/platforms/applications and other third party content and/or systems are yet other examples.

When a new Quixomatic Website is created, it becomes available to view in a browser via a system URL under the Quixomatic domain (e.g. http://www.quixomatic.com/s/62H75/). As it is highly desirable for Subscribers to host this content under their own domain name, a tab denominated as “Domain” or other suitable name, allows a Subscriber to attach a third party's domain name to the newly created Quixomatic Website. To do this, a Subscriber who has purchased a domain name (e.g. myrestaurant.com.au) from a 3^{rd} party registrar may access their 3^{rd} party domain name management system and set Quixomatic as the destination for hosted content. There are a few ways the Internet domain name system facilitates this, however in the example of setting up www.myrestaurant.com.au as a CNAME, the Subscriber would log into their 3^{rd} party domain management account for myrestaurant.com.au and enter “www” as the NAME, HOST or ALIAS and “sites.quixomatic.com” as the VALUE or DESTINATION of the CNAME. Once this is complete, the Subscriber can visit the Subscriber Customization Console “Domain Tab” and enter/save the domain name www.myrestaurant.com.au. Then, the Quixomatic Website will resolve to this domain name when a user accesses it as a web address in a browser. The system URL for the Quixomatic Website (www.quixomatic.com/s/[site-id] will also subsequently forward to the domain name for as long as the domain name is linked via the Subscriber Customization Console.

A Subscriber Customization Console tab denominated as “Updates” or other suitable name allows a Subscriber to get the most current content from connected profiles and internet pages. In other words, once the Quixomatic Website is created, when the subscriber causes an update to be performed, the system contacts all of the 3^{rd} party sources used to construct the Quixomatic Website, and extracts any relevant, new content or other resources that have been updated on those sources since the Quixomatic Website was last built.

### Palette Generator 102

As noted above, Content assets collected via APIs identified in the source array are programmatically inspected to determine additional information that can be used to automatically allocate settings such as background colors, foreground colors, accent colors, palette variations, and the like. The Palette Generator automatically samples colors from the data extracted from the 3^{rd} party sources, and uses those sampled colors in generating (or updating) the Quixomatic Website.

Automatic sampling of colors can be broken down into a number of steps:
1. A primary image is selected from the Subscriber's content APIs by working through a priority list of images. For example, if a Facebook Cover Image exists, it is always used, the remaining Facebook photos are inspected until one of a suitable size is found.
2. The primary image is retrieved and stored.
3. The primary image is resampled into a smaller image where its longest side is 150 pixels and its aspect ratio maintained.
4. The resampled image is “averaged” by removing the lowest 5 bits of each of the red, green and blue 8-bit components of each pixel.
5. An array of colors is then generated, keyed off the color and containing the number of occurrences of each of those colors. For example: [‘C05050’=>5, ‘9090F0’=>4′, . . . ] establishes that the color C05050 occurs 5 times within the image and the color 9090F0 occurs 4 times within the image.
6. Each of the colors in the color array are potentially moved into 3 possible buckets or discarded altogether:
   a. Colors are determined to be “Dark Colors” when their red, blue and green component values total less than 200.
   b. Colors are determined to be “Light Colors” when their red, blue and green component values total more than 475.
      Main Colors are those that are (i) not in either of the other two buckets, and (ii) the red, blue and green component values being of at least 50 value difference to one another. For example, the test passes if the Red value is 190, the blue value is 185 and the green value is 120 (because the difference between 190 and 120 is more than 50). This latter requirement ensures that colors put into this “Main Color” bucket will never be greyscale, will not be dark and will not be light.

The most commonly found color within each bucket is automatically chosen for a corresponding default selection when a site is initially created. For example, the most commonly found Dark Color may be assigned as the default Background Color, the most commonly found Light Color may be assigned as the default Text Color, and the most commonly found Main Color may be assigned as the default Highlight Color. The Highlight Color is used differently in different themes, but for example, can be the color of the module borders, the navigation text, and some headings within the Quixomatic Website. As well as the default selection that is made, the other colors in each of the 3 buckets are presented to the user to be able to make a selection from when customizing the colors of their Quixomatic Website.

### Source Array 114

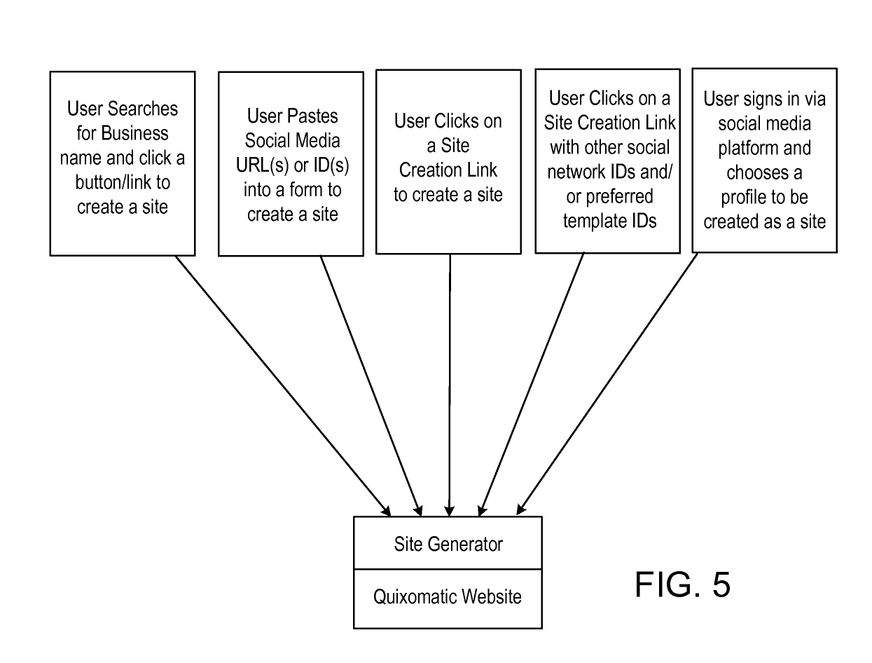

An important part of the overall experience is the mechanism with which the Subscriber's establish their 3^{rd} Party Sources. Currently this achieved for different 3^{rd} parties with one of three different mechanisms: search, OAuth and String Identifier. Below we'll summarize by describing five examples of these mechanisms (FIG. 5).

Establishing Identity with Search

A Subscriber may use a text field within a web page to start typing their identity, whereby the system will perform a dynamic search with the 3^{rd} party to pull back results beginning with the letters or numbers as they are typed (FIG. 6). This is commonly referred to as “auto-complete”. An example of this type of identity mechanism is Facebook where Subscribers will dynamically search through a list of all Facebook pages by business name as the user types in order to select their Facebook Page from the list presented. The act of selecting their Facebook Page initiates the site generation process.

In addition the Subscriber could simply type or paste their social media URL into the text field such as shown in FIG. 7.

The identifier or search used could be anything that can be mapped to or indexed to an account identity such as a business name, phone number, address, geocode, URL.

Establishing Identity with OAuth

OAuth is offered by many online content providers and provides a user-friendly way for a Subscriber to authenticate and share their 3^{rd} party data with the system. The Subscriber will simply click on a link provided by the system that will take the Subscriber to a login page on the 3^{rd} party provider's site (see FIG. 8). Assuming the Subscriber authenticates, they are then returned to the Subscriber Customization Console and the system will communicate with the 3^{rd} party provider to access the Subscriber content. Instagram, Soundcloud and Youtube are three such services where the Subscriber's identity is established in this manner.

Establish Identify with String Identification

When a system offers no OAuth API and no search API, and where the data the Subscriber is using is considered to be public, the system will allow a Subscriber to type a unique ID given by the 3^{rd} party into the system. In the example of OpenMenu, a Subscriber (e.g., a restaurant owner) creates an account and enters its menu data into the OpenMenu system. When they do this, they are provisioned with a unique identification string for this menu that they can subsequently pass to Quixomatic so that the system can use the OpenMenu API to retrieve the menu data. In the exact same way, the system can also accept multiple unique identifiers in a single form field to generate a Quixomatic Website (FIG. 9).

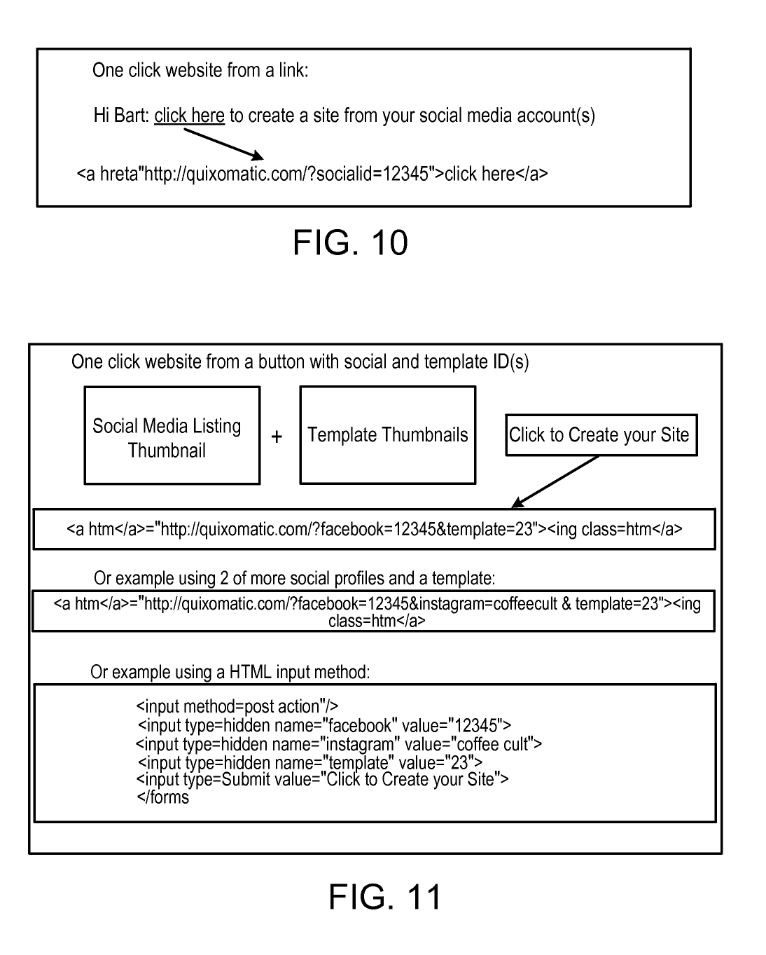

String Identification can also be used in simple text links in email or html web pages (FIG. 10)

Canned button implementations may be mixed with a multiplicity of identifiers. In FIG. 11, we see a mix of template ID and multiple social media account IDs.

### 3^{rd} Party Sources 116

Once identified, the data from 3^{rd} party sources is collated into the site data. Each API is unique and the system software accounts for each of the different APIs associated with different 3^{rd} party sources.

Quixomatic Websites are updated regularly (e.g., periodically such as every 5 minutes, every hour, once a day, etc.) from the content in their respective 3^{rd} party sources. For example, every half an hour, all of the data for a Quixomatic Website is refreshed from the 3^{rd} party content that was used to generate that site.

In other words, when a Quixomatic Website is due for a refresh (every 30 minutes), an item is placed on to a software queue for each of the 3^{rd} Party Sources that pertain to that Quixomatic Website. For example, Quixomatic Website ID “S44RL” has linked content from Facebook, Instagram and OpenMenu. In this case, an item is placed on each of the Facebook, Instagram and OpenMenu queues. When items are processed from the queues, first the queue settings are checked to see how many requests have been recently made to that source and pauses made as necessary not to breach API request limits. An example of this check is, for any Facebook update, the system attempts to reduce the number of requests to less than 10 requests per minute to avoid reaching any API limits. The request is then executed to retrieve the content from the 3^{rd} party source before updating the Quixomatic Website. The reason for having a separate queue per 3^{rd} party source is to allow for special conditions such as rate limiting to be applied to once source whilst not preventing the system from updating from the other sources.

The system uses a data collision avoidance strategy that is one of a replacement strategy. That is, upon successful retrieval of data from the a 3^{rd} party source, the entirety of the data stored about one Quixomatic Website from one 3^{rd} Party Source is replaced within the Quixomatic Site with the newly retrieved version of that data.

### Content Module Generator 110

In real time, while generating the pages of a Quixomatic Website, the site data is inspected and processed to determine the content module settings for the selected theme. Since each theme has a prioritized list of modules that can be used for each page template within the theme, the site data is processed to check if the relevant data exists, is it well-formed and is there enough content to be useful in the context of the module. This is how the page template becomes aware of which modules will ultimately be collated to construct the page and deliver it to Quixomatic Website Visitors.

Each page template and layout is designed and built according to the number and kind of modules that are to be included in the Quixomatic Website, as determined by the content module settings. For example, the page template may receive instructions via content module settings that are essentially: page_template=home_stockholm_template: include (header, phone_number(click2call) nav, homepage_feature, about_us, news_feed, social_links, footer) in that order.

Note that other modules have been omitted from the instruction on purpose due to the required content to populate them being deemed insufficient or not required for that template by the process. For example if the geocode of the address was found to be a city level geocode, the map module would be removed from the instruction. Another example would be if there was no menu content, then the menu module would similarly, not be included.

When similar or identical content is available from multiple sources, the content is merged together to provide a single instance of the content in the site. An example might be a Subscriber's photos, which have been gathered from both Facebook and Instagram leading to a situation where there are multiple versions of the “same” photograph retrieved by the subject system. In order to obviate displaying multiple versions of the “same” photograph or photographs or other duplicated content, the albums list is merged together for display on the Quixomatic Website so that the otherwise duplicated photographs displayed only once on the Quixomatic Website. There are other types of content for which only one version is displayed on the Quixomatic Website. An example of this is the phone number that may be retrieved from OpenMenu and from Facebook. In this specific example, the system always displays the Facebook version of this phone number. The system makes a decision about the most authoritative source of each piece of content.

### Transaction/Call-to-Action Generator 108

Business websites are, in the most part, created by businesses for the purpose of informing, influencing, and importantly, to bring more commercial activity to the business. To do this effectively, successful websites have very obvious and consistent methods to convert a website visitor into a lead. Some businesses prefer customers phone or even visit the business. Some enable a complete commercial transaction on the website itself such as a purchase or a booking. There are key UI elements provided in each template or theme that focus on the lead-generation, transactional aspects of Quixomatic Websites. As with the content modules noted, the lead-generation elements of the themes may be augmented or added to in order to provide a better user experience and thereby increase the potential for lead generation. For example, phone numbers are processed by the system to ensure they are well formed and validly written for example with the correct country codes and country exit codes to facilitate use of the number “as is” without need to add further digits. This is important to ensure correct formatting on display. It will also determine whether “click2call” functionality (the website functionality that enables a phone number to be interacted with to initiate a phone call, typically on a mobile device) is activated, whether the phone number is simply printed to the page or whether it is shown at all. Another example is location address. Addresses are processed to gain geocode information (i.e. x/y map co-ordinates) as well as geocode granularity (i.e. is it street level, suburb level or country level geocoding) and determine confidence levels of returned geocodes. Based on this processing, module settings are created such as importance, map module zoom settings and/or whether we show a map at all.

One example is when a business phone number is deemed to be well-formed for the country, a “click to call” link is provided prominently within each theme. Another example is when a business address is provided within the data collected by the subject system from third party sites, a map is provided so visitors to the Quixomatic Website may more easily locate the Subscriber's business location.

Another example is a restaurant booking/ordering system whereby if one of the system subscriber's social webpages has a feature providing integration with a restaurant booking or ordering provider, that fact will be identified and used in generating the Subscriber's Quixomatic Website as it clearly indicates that the subscriber values this functionality. Consequently, the restaurant booking/ordering integration will be specially highlighted on the generated Quixomatic Website.

### Navigation Generator 106

Similar to modules above, each theme automatically generates a list of possible pages and a content test in order to demonstrate the proposed Quixomatic Webpage prior to it being made available to third parties over the Internet. This enables each element with the newly generated Quixomatic Website to be examined to determine its accuracy and whether it is in fact wanted in the page that will be deployed over the Internet. An example would be a menu link to the menu page that should be displayed only if there is menu content. In this way, sites with wildly varying content are handled appropriately by adding navigation links only to pages that make have the appropriate content according to the Site Data.

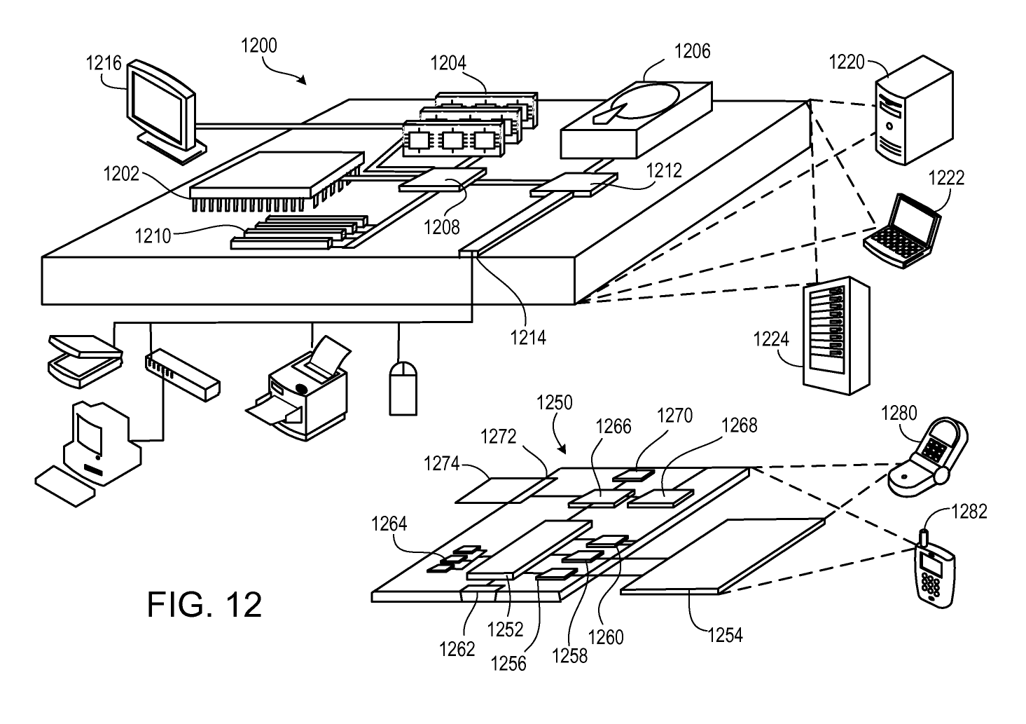

FIG. 12 is a block diagram of computing devices 1200, 1250 that may be used to implement the systems and methods described in this document, as either a client or as a server or plurality of servers. Computing device 1200 is intended to represent various forms of digital computers, such as laptops, desktops, workstations, personal digital assistants, servers, blade servers, mainframes, and other appropriate computers. Computing device 1250 is intended to represent various forms of mobile devices, such as personal digital assistants, cellular telephones, smartphones, and other similar computing devices. Additionally computing device 1200 or 1250 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 1200 includes a processor 1202, memory 1204, a storage device 1206, a high-speed interface 1208 connecting to memory 1204 and high-speed expansion ports 1210, and a low speed interface 1212 connecting to low speed bus 1214 and storage device 1206. Each of the components 1202, 1204, 1206, 1208, 1210, and 1212, are interconnected using various busses, and may be mounted on a common motherboard or in other manners as appropriate. The processor 1202 can process instructions for execution within the computing device 1200, including instructions stored in the memory 1204 or on the storage device 1206 to display graphical information for a GUI on an external input/output device, such as display 1216 coupled to high speed interface 1208. In other implementations, multiple processors and/or multiple buses may be used, as appropriate, along with multiple memories and types of memory. Also, multiple computing devices 1200 may be connected, with each device providing portions of the necessary operations (e.g., as a server bank, a group of blade servers, or a multi-processor system).

The memory 1204 stores information within the computing device 1200. In one implementation, the memory 1204 is a volatile memory unit or units. In another implementation, the memory 1204 is a non-volatile memory unit or units. The memory 1204 may also be another form of computer-readable medium, such as a magnetic or optical disk.

The storage device 1206 is capable of providing mass storage for the computing device 1200. In one implementation, the storage device 1206 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1204, the storage device 1206, or memory on processor 1202.

The high speed controller 1208 manages bandwidth-intensive operations for the computing device 1200, while the low speed controller 1212 manages lower bandwidth-intensive operations. Such allocation of functions is exemplary only. In one implementation, the high-speed controller 1208 is coupled to memory 1204, display 1216 (e.g., through a graphics processor or accelerator), and to high-speed expansion ports 1210, which may accept various expansion cards (not shown). In the implementation, low-speed controller 1212 is coupled to storage device 1206 and low-speed expansion port 1214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1200 may be implemented in a number of different forms, as shown in the figure. For example, it may be implemented as a standard server 1220, or multiple times in a group of such servers. It may also be implemented as part of a rack server system 1224. In addition, it may be implemented in a personal computer such as a laptop computer 1222. Alternatively, components from computing device 1200 may be combined with other components in a mobile device (not shown), such as device 1250. Each of such devices may contain one or more of computing device 1200, 1250, and an entire system may be made up of multiple computing devices 1200, 1250 communicating with each other.

Computing device 1250 includes a processor 1252, memory 1264, an input/output device such as a display 1254, a communication interface 1266, and a transceiver 1268, among other components. The device 1250 may also be provided with a storage device, such as a microdrive or other device, to provide additional storage. Each of the components 1250, 1252, 1264, 1254, 1266, and 1268, are interconnected using various buses, and several of the components may be mounted on a common motherboard or in other manners as appropriate.

The processor 1252 can execute instructions within the computing device 1250, including instructions stored in the memory 1264. The processor may be implemented as a chipset of chips that include separate and multiple analog and digital processors. Additionally, the processor may be implemented using any of a number of architectures. For example, the processor 1210 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 1250, such as control of user interfaces, applications run by device 1250, and wireless communication by device 1250.

Processor 1252 may communicate with a user through control interface 1258 and display interface 1256 coupled to a display 1254. The display 1254 may be, for example, a TFT (Thin-Film-Transistor Liquid Crystal Display) display or an OLED (Organic Light Emitting Diode) display, or other appropriate display technology. The display interface 1256 may comprise appropriate circuitry for driving the display 1254 to present graphical and other information to a user. The control interface 1258 may receive commands from a user and convert them for submission to the processor 1252. In addition, an external interface 1262 may be provided in communication with processor 1252, so as to enable near area communication of device 1250 with other devices. External interface 1262 may provide, for example, for wired communication in some implementations, or for wireless communication in other implementations, and multiple interfaces may also be used.

The memory 1264 stores information within the computing device 1250. The memory 1264 can be implemented as one or more of a computer-readable medium or media, a volatile memory unit or units, or a non-volatile memory unit or units. Expansion memory 1274 may also be provided and connected to device 1250 through expansion interface 1272, which may include, for example, a SIMM (Single In Line Memory Module) card interface. Such expansion memory 1274 may provide extra storage space for device 1250, or may also store applications or other information for device 1250. Specifically, expansion memory 1274 may include instructions to carry out or supplement the processes described above, and may include secure information also. Thus, for example, expansion memory 1274 may be provide as a security module for device 1250, and may be programmed with instructions that permit secure use of device 1250. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1264, expansion memory 1274, or memory on processor 1252 that may be received, for example, over transceiver 1268 or external interface 1262.

Device 1250 may communicate wirelessly through communication interface 1266, which may include digital signal processing circuitry where necessary. Communication interface 1266 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1268. In addition, short-range communication may occur, such as using a Bluetooth, WiFi, or other such transceiver (not shown). In addition, GPS (Global Positioning System) receiver module 1270 may provide additional navigation- and location-related wireless data to device 1250, which may be used as appropriate by applications running on device 1250.

Device 1250 may also communicate audibly using audio codec 1260, which may receive spoken information from a user and convert it to usable digital information. Audio codec 1260 may likewise generate audible sound for a user, such as through a speaker, e.g., in a handset of device 1250. Such sound may include sound from voice telephone calls, may include recorded sound (e.g., voice messages, music files, etc.) and may also include sound generated by applications operating on device 1250.

The computing device 1250 may be implemented in a number of different forms, as shown in the figure. For example, it may be implemented as a cellular telephone 1280. It may also be implemented as part of a smartphone 1282, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A method performed by data processing apparatus, the method comprising:
receiving input identifying a plurality of third-party websites;
establishing communication with each of the plurality of third-party websites;
aggregating existing digital content residing at each of the plurality of third-party websites;
automatically generating a new website based on at least some of the aggregated existing digital content; and
deploying the generated new website.

2. The method of claim 1, wherein the generated new website comprises a customized user interface, or a customized user experience, or both, unrelated to any of the third party websites.

3. The method of claim 1, wherein each of the plurality of third-party websites has an association with a common subscriber, wherein the subscriber has an account with each of the third-party websites.

4. The method of claim 3, wherein establishing communication with the plurality of third-party websites comprises accessing the subscriber's account on each of the plurality of third-party websites.

5. The method of claim 3, wherein the existing digital content comprising content personal to the subscriber including one or more of photos, videos, customized applications, or documents.

6. The method of claim 1 further comprising:
receiving input from the subscriber via the deployed new website;
determining that the received input effects a change to one or more of the existing digital content items that were used to generate the new website; and
propagating the change back to one or more third-party websites that host a copy of the one or more digital content items that were changed at the deployed new website.

7. The method of claim 6, wherein propagating the change comprising transmitting a changed version of the digital content item to the one or more third-party websites.

8. The method of claim 1, wherein the plurality of third-party websites comprises one or more of social media sites, video aggregators, photo-sharing sites, listing sites, or blogging sites.

9. The method of claim 1, wherein establishing communication with each of the plurality of third-party websites may be performed serially or in parallel, or a combination of both.

10. The method of claim 1, wherein aggregating existing digital content residing at each of the plurality of third-party websites may be performed serially or in parallel, or a combination of both.

11. The method of claim 1, wherein automatically generating the new website comprises determining one or more new colors for the new site based on colors appearing in the aggregated digital content.

12. The method of claim 1, wherein the aggregated digital content includes a plurality of digital photos, and wherein automatically generating the new website comprises generating a slide-show experience and gallery features from the plurality of digital photos.

13. The method of claim 1, wherein the aggregated digital content includes text, and wherein automatically generating the new website comprises generating a blog post from the text.

14. The method of claim 1, wherein the aggregated digital content includes meta information, and wherein automatically generating the new website comprises generating site modules and html meta content from the meta information.

15. The method of claim 1, wherein the aggregated digital content includes information defining transactional behavior, and wherein automatically generating the new website comprises generating transactional experiences including one or more of phone call actions/buttons, buy now buttons, get directions, email forms, or chat modules from the information defining transactional behavior.

16. The method of claim 1 further comprising:
sensing a change to digital content in the newly generated website; and
syncing the change to digital content with one or more third-party websites from whence the digital content originated.

17. The method of claim 1 further comprising:
automatically polling a third-party website to determine whether a change to an existing digital content item residing at that website has occurred;
upon determining that a change has occurred, retrieving information corresponding to the change from the third-party website; and
using the retrieved information to update the newly generated website.

18. The method of claim 1 further comprising:
receiving input from the subscriber corresponding to a refresh request;
communicating with the plurality of third-party websites to aggregate any new or changed digital content; and
using the aggregated new or changed digital content to update the newly generated website.

19. The method of claim 1 further comprising collecting online identities, each online identity relating to a subscriber's access to a third-party website.

20. The method of claim 19 wherein an online identity corresponds to a username.

21. The method of claim 19, wherein establishing communication with the third-party websites is performed using the collected online identities.

22. The method of claim 19, wherein collecting the online identities is performed automatically using third-party search services.

23. A system comprising:
one or more processors configured to execute computer program instructions; and
computer storage media encoded with computer program instructions that, when executed by one or more processors, cause a computer device to perform operations comprising:
receive input identifying a plurality of third-party websites;
establish communication with each of the plurality of third-party websites;
aggregate existing digital content residing at each of the plurality of third-party websites;
automatically generate a new website based on at least some of the aggregated existing digital content; and
deploy the generated new website.

24. The system of claim 23, wherein the generated new website comprises a customized user interface, or a customized user experience, or both, unrelated to any of the third party websites.

25. The system of claim 23, wherein each of the plurality of third-party websites has an association with a common subscriber, wherein the subscriber has an account with each of the third-party websites.

26. The system of claim 25, wherein establishing communication with the plurality of third-party websites comprises accessing the subscriber's account on each of the plurality of third-party websites.

27. The system of claim 25, wherein the existing digital content comprising content personal to the subscriber including one or more of photos, videos, customized applications, or documents.

28. The system of claim 23 further comprising:
receiving input from the subscriber via the deployed new website;
determining that the received input effects a change to one or more of the existing digital content items that were used to generate the new website; and
propagating the change back to one or more third-party websites that host a copy of the one or more digital content items that were changed at the deployed new website.

29. The system of claim 28, wherein propagating the change comprising transmitting a changed version of the digital content item to the one or more third-party websites.

30. The system of claim 23, wherein the plurality of third-party websites comprises one or more of social media sites, video aggregators, photo-sharing sites, listing sites, or blogging sites.

31. The system of claim 23, wherein establishing communication with each of the plurality of third-party websites may be performed serially or in parallel, or a combination of both.

32. The system of claim 23, wherein aggregating existing digital content residing at each of the plurality of third-party websites may be performed serially or in parallel, or a combination of both.

33. The system of claim 23, wherein automatically generating the new website comprises determining one or more new colors for the new site based on colors appearing in the aggregated digital content.

34. The system of claim 23, wherein the aggregated digital content includes a plurality of digital photos, and wherein automatically generating the new website comprises generating a slide-show experience and gallery features from the plurality of digital photos.

35. The system of claim 23, wherein the aggregated digital content includes text, and wherein automatically generating the new website comprises generating a blog post from the text.

36. The system of claim 23, wherein the aggregated digital content includes meta information, and wherein automatically generating the new website comprises generating site modules and html meta content from the meta information.

37. The system of claim 23, wherein the aggregated digital content includes information defining transactional behavior, and wherein automatically generating the new website comprises generating transactional experiences including one or more of phone call actions/buttons, buy now buttons, get directions, email forms, or chat modules from the information defining transactional behavior.

38. The system of claim 23 further comprising:
sensing a change to digital content in the newly generated website; and
syncing the change to digital content with one or more third-party websites from whence the digital content originated.

39. The system of claim 23 further comprising:
automatically polling a third-party website to determine whether a change to an existing digital content item residing at that website has occurred;
upon determining that a change has occurred, retrieving information corresponding to the change from the third-party website; and
using the retrieved information to update the newly generated website.

40. The system of claim 23 further comprising:
receiving input from the subscriber corresponding to a refresh request;
communicating with the plurality of third-party websites to aggregate any new or changed digital content; and
using the aggregated new or changed digital content to update the newly generated website.

41. The system of claim 23 further comprising collecting online identities, each online identity relating to a subscriber's access to a third-party website.

42. The system of claim 41 wherein an online identity corresponds to a username.

43. The system of claim 41, wherein establishing communication with the third-party websites is performed using the collected online identities.

44. The system of claim 41, wherein collecting the online identities is performed automatically using third-party search services.

45. A non-transitory machine readable medium bearing instructions that when performed by data processing apparatus perform operations comprising:
receiving input identifying a plurality of third-party websites;
establishing communication with each of the plurality of third-party websites;
aggregating existing digital content residing at each of the plurality of third-party websites;
automatically generating a new website based on at least some of the aggregated existing digital content; and
deploying the generated new website.
